(19) United States
(12) Patent Application Publication
(10) Pub. No.: US 2024/0178592 A1
(43) Pub. Date: May 30, 2024

(54) MINIATURIZED HIGH-SPEED INTERPOSER

(71) Applicant: Amphenol Corporation, Wallingford, CT (US)

(72) Inventors: Trent K. Do, Lititz, PA (US); Jim Hileman, Carlisle, PA (US); Paul R. Taylor, Mechanicsburg, PA (US); Matthew S. Emenheiser, Etters, PA (US)

(73) Assignee: Amphenol Corporation, Wallingford, CT (US)

(21) Appl. No.: 18/521,856

(22) Filed: Nov. 28, 2023

Related U.S. Application Data
(60) Provisional application No. 63/514,718, filed on Jul. 20, 2023.
(60) Provisional application No. 63/428,669, filed on Nov. 29, 2022.

(51) Int. Cl. H01R 12/71; H01R 13/41; H01R 13/6585; H01R 43/16; H01R 43/20

(52) U.S. Cl. CPC H01R 12/712; H01R 13/41; H01R 13/6585; H01R 43/16; H01R 43/205

(57) ABSTRACT

A compact interposer with shields and multiple electrical contacts held in a housing. Each shield is compact, being disposed in a vertical plane perpendicular to the top and bottom surfaces of the housing and between two adjacent electrical contacts respectively on opposing sides of the shield. The shield includes a plurality of shield contacts extending above the top surface and/or below the bottom surface of the housing. During operation, the shield is configured to reduce crosstalk between high-speed signals carried in the electrical contacts on opposing sides of the shield. Optionally, when in a compressed state, the shield contact may be configured to contact the shield body to shunt a distal end of the shield contact. The shield body and shield contacts may be stamped from the same sheet of metal. The shield contacts may have properties that provide reliable operation of the interposer.

### CROSS-REFERENCE TO RELATED APPLICATIONS

This application claims priority to and the benefit of U.S. Provisional Application Ser. No. 63/514,718, filed on Jul. 20, 2023, entitled “MINIATURIZED HIGH-SPEED INTERPOSER.” This application also claims priority to and the benefit of U.S. Provisional Application Ser. No. 63/428,669, filed on Nov. 29, 2022, entitled “MINIATURIZED HIGH-SPEED INTERPOSER.” The entire contents of these applications are incorporated herein by reference in their entirety.

### FIELD

This patent application relates generally to interconnection systems, such as those including electrical connectors, used to interconnect electronic assemblies.

### BACKGROUND

Electrical connectors are used in many electronic systems. It is generally easier and more cost effective to manufacture a system as separate components that are electrically connected through separable interfaces. With separable interfaces, the components may be separately manufactured and then simply assembled into an overall system. In use, components can be added or replaced in the electronic system, such as to replace a defective component or to enable higher-performing components to be added to the system to upgrade the electronic system.

In some instances, the components are themselves subassemblies, which are often manufactured by connecting semiconductor devices and other components to a printed circuit board (PCB). The electronic system may then be assembled by joining the subassemblies. Two-piece connectors are often used for this purpose, with one piece of the connector being mounted on the PCBs of each of two subassemblies to be joined. The subassemblies are joined by mating one piece of the connector with the other.

Components may also be joined through interposers. An interposer has one or more separable interfaces. A separable interface that mates with a component may have a planar array of compliant contacts. A component may be mated to the interposer by pressing the component against the compliant contacts. For example, a semiconductor device, such as a processor chip, may have an array of pads or other conductive structures on a surface. The pads may be aligned with the compliant contacts of the interposer such that pressing the device against the interposer makes connections between the compliant contacts and the pads or other conductive structures.

Each of the compliant contacts may extend through the interposer to an opposite surface at which a second end of the contact is connected to a second component. In many system architectures, that second component may be a PCB, which may also include an array of pads to which the second ends of the contacts of the interposer are connected. Those connections may be made through compliant contacts on the second ends of the contacts, forming a separable interface. Alternatively, in some interposers, the second end is fixed to a second component, such as via soldering to a PCB.

Interposers may be used in combination with mechanical components that urge one or more components towards separable interface(s) of the interposer. An interposer that connects a semiconductor chip to a PCB, for example, may be used in combination with components that press the semiconductor chip towards a separable interface of the interposer. If the interposer is connected to the PCB through a separable interface, the mechanical components may also press the interposer against the PCB so that the compliant contacts facing the PCB generate sufficient force to make connections to the PCB.

The compliant contacts of interposers may be capable of carrying high-speed signals, low-speed signals or power. Signal interference, such as crosstalk, may be caused by high-speed signals carried by electrical contacts that are close to each other. To reduce crosstalk, compliant contacts positioned between other compliant contacts intended for carrying high-speed signals may be dedicated for ground connections. Alternatively, shields may be added between compliant contacts intended for carrying high-speed signals to reduce the crosstalk. These approaches increase the size of the interposer, which is counter to the objective of miniaturization of many electronic systems.

### SUMMARY

Aspects of the present application relates to miniaturized high-speed interposers and method of manufacturing thereof.

Some embodiments relate to an interposer. The interposer may include an insulative housing comprising: a top surface and a bottom surface opposite the top surface; a plurality of first openings extending between the top surface and the bottom surface and arranged in a plurality of parallel lines; and a channel extending between the top surface and the bottom surface and disposed between two lines of the first openings respectively adjacent opposing sides of the channel; a plurality of electrical contacts each disposed within a respective opening of the plurality of first openings, wherein each electrical contact includes a first contact portion extending above the top surface of the insulative housing; and a shield disposed in the channel, the shield comprising a plurality of first shield contacts extending from a first edge of the shield, wherein the plurality of first shield contacts extend through the top surface of the insulative housing.

Optionally, the at least one channel is partially closed on the top surface of the insulative housing such that a plurality of second openings are disposed on the top surface along an elongated direction of the at least one channel; and shield contacts of the plurality of first shield contacts extend through respective openings of the plurality of second openings.

Optionally, the shield is disposed between and adjacent to a first group of electrical contacts of the plurality of electrical contacts in openings in a first line of the plurality of parallel lines and a second group of electrical contacts of the plurality of electrical contacts in openings in a second line of the plurality of parallel lines, whereby the shield reduces crosstalk between signals carried by the first group of electrical contacts and the second group of electrical contacts.

Optionally, the shield is a plate disposed in a first plane, and the first plane is perpendicular to the top and bottom surfaces of the insulative housing.

Optionally, electrical contacts of the first and second groups of the plurality of electrical contacts are configured to carry high-speed signals.

Optionally, the shield extends in a first direction parallel to the plurality of parallel lines; and the plurality of first shield contacts of the shield are aligned in a second direction perpendicular to the first direction with respective contacts of the first group of electrical contacts and the second group of electrical contacts.

Optionally, a center-to-center spacing in the second direction between the first group of electrical contacts and the second group of electrical contacts is between 0.9 mm and 1.1 mm.

Optionally, Optionally, a center-to-center spacing in the second direction between the first shield contacts and the first group of electrical contacts and the second group of electrical contacts is between 0.4 mm and 0.6 mm.

Optionally, the channel is a first channel, and the shield is a first shield; the interposer further comprises a plurality of shields including the first shield; the interposer further comprises a plurality of channels including the first channel; and a line of electrical contacts of the plurality of electrical contacts disposed in openings of a line of the plurality of parallel lines of openings is disposed between two shields of the plurality of shields adjacent opposite sides of the line of electrical contacts.

Optionally, for each electrical contact of the first and the second groups of electrical contacts, when the electrical contact is in an uncompressed state, the first contact portion of the electrical contact extends a first distance above the top surface of the insulative housing; for each shield contact of the plurality of first shield contacts of the at least one shield, when the shield contact is in an uncompressed state, a contact portion of the shield contact extends a second distance above the top surface of the insulative housing; and the second distance is shorter than the first distance.

Optionally, each of the first and the second groups of electrical contacts is configured to be compressed with a spring rate corresponding to a first stiffness; each of the plurality of first shield contacts includes a beam having a second stiffness; and the second stiffness is higher than the first stiffness.

Optionally, the interposer described herein may be in combination with a mating component comprising a flat surface with a plurality of contact areas formed thereon. The first contact portions of the first and the second groups of electrical contacts and the contact portions of the plurality of first shield contacts are in electrical contact with respective contact areas formed on the flat surface of the mating component.

Optionally, a beam of each of the first and the second groups of electrical contacts has a length longer than a length of the beam of each of the plurality of first shield contacts of the shield.

Optionally, the beam of each of the plurality of first shield contacts is configured to deflect in the first plane.

Optionally, each of the first and second groups of electrical contacts is configured to deflect around an axis that is parallel to the top surface of the insulative housing.

Optionally, the plurality of first shield contacts are disposed in the first plane.

Optionally, a beam of each of the plurality of first shield contacts has an inner edge facing the first edge of the shield and an outer edge comprising a contact surface.

Optionally, the first edge of the shield comprises a plurality of castellations each facing the inner edge of a respective shield contact of the plurality of first shield contacts and configured to limit deflection of the respective shield contact.

Optionally, the respective shield contact facing each castellation of the plurality of castellations extends from the first edge of the shield at a distance from the castellation such that the respective shield contact is pivotable about a point on the first edge from which the respective shield contact extends.

Optionally, each of the plurality of first shield contacts comprises a beam configured to deflect at least partially in a first plane perpendicular to the top and bottom surfaces of the insulative housing. When the shield contact of the plurality of first shield contacts is in a compressed state, a portion of the beam of the shield contact is in contact with a body of the shield.

Optionally, the shield further comprises a plurality of second shield contacts extending from a second edge of the shield opposite the first edge; each of the plurality of second shield contacts is configured to deflect at least partially in the first plane; and when the shield contact of the plurality of second shield contacts is in the compressed state, a portion of a beam of the shield contact is in contact with the body of the shield.

Optionally, a first shield contact of the plurality of first shield contacts and a second shield contact of the plurality of second shield contacts are disposed at corresponding locations respectively on the first edge and the second edge.

Optionally, when the first shield contact is in the compressed state, the first shield contact is in contact with a corner of the first edge, whereby the first shield contact is shunted to the shield body.

Optionally, when the first shield contact is in the compressed state, the first shield contact is shunted to the shield body via a shunting area at a corner where a side of the body of the shield and the first edge intersect.

Optionally, for each of the plurality of first shield contacts, the beam comprises: a first portion extending from the first edge of the shield and disposed in the first plane; and a second portion extending from the first portion and having at least a portion bending away from the first plane.

Optionally, for each of the plurality of first shield contacts, the second portion of the beam comprises: a first portion extending from the first portion of the beam and is disposed in the first plane; and an end portion extending from the first portion of the second portion of the beam at a non-zero angle with respect to the first plane and is configured to contact the first edge when the shield contact is in the compressed state.

Optionally, for each of the plurality of first shield contacts: the beam extends from the first edge of the shield at a distance to provide a clearance such that the beam does not come into contact with the first edge when the shield contact of the plurality of first shield contacts is in the compressed state.

Optionally, the channel comprises an interior wall; and the shield comprises one or more tabs configured to be pressed against the interior wall of the channel to retain the shield in the channel.

Optionally, the one or more tabs protrude on a first side of the shield.

Optionally, each electrical contact of the plurality of electrical contacts further includes a second contact portion extending below the bottom surface of the insulative housing.

Optionally, the shield further comprises a plurality of second shield contacts extending from a second edge of the shield; the second edge is opposite the first edge of the shield; and the plurality of second shield contacts extend through the bottom surface of the insulative housing.

Optionally, the plurality of first shield contacts and the plurality of second shield contacts are stamped from a single sheet of metal.

Optionally, each of the plurality of electrical contacts is C-shaped.

Optionally, each of the plurality of electrical contacts is configured such that a first tip and a second tip of the C-shaped electrical contact are in contact to form a conductive path between the first contact portion and the second contact portion of the electrical contact through the first and second tips of the electrical contact, when the interposer is compressed by a pair of substrates.

Optionally, the shield is slidably mounted in the channel.

Optionally, the channel comprises an interior wall, and the shield comprises one or more tabs pressing against the interior wall of the channel such that the shield is retained in the channel.

Optionally, the one or more tabs each is stamped from a body of the shield.

Some embodiments relate to a method for manufacturing an interposer. The method may include inserting a plurality of electrical contacts into respective first openings extending between a top surface and a bottom surface opposite the top surface of a housing, wherein the first openings are arranged in a plurality of lines; stamping from a sheet of metal a shield including a plurality of shield contacts extending from a first edge of the shield; and inserting the shield into a channel of a housing such that the plurality of shield contacts extend through the top surface, wherein the channel is disposed between two adjacent lines of the first openings.

Optionally, the channel of the housing is partially closed at the top surface of the housing such that a plurality of second openings are disposed on the top surface along an elongated direction of the channel; and inserting the shield into the channel of the housing comprises inserting the shield into the channel such that the plurality of shield contacts of the shield extend through respective openings of the plurality of second openings above the top surface.

Optionally, the method may further include retaining the shield in the channel. Optionally, stamping the shield comprises stamping one or more tabs in the shield; and retaining the at least one shield in the channel comprises engaging the one or more tabs with a wall of the channel.

Optionally, stamping the shield comprises stamping a blank comprising the shield and a carrier strip from the sheet of metal, wherein the carrier strip is connected to the shield.

Optionally, the method may further include severing the carrier strip from the shield after inserting the shield in the channel.

Optionally, the carrier strip connects to a second edge of the shield opposite the first edge.

Optionally, stamping the shield further comprises stamping additional shield contacts on the second edge of the shield.

Optionally, the shield is a first shield, and the channel is a first channel; and the method may further include inserting a second shield into a second channel of the housing such that a plurality of shield contacts of the second shield extend through the top surface, wherein the second channel is disposed between two adjacent lines of the first openings.

Optionally, the method may further include bending a portion of each of the plurality of shield contacts away from a plane of the shield before inserting the shield into the channel of the housing.

Some embodiments relate to an interposer. The interposer may include an insulative housing comprising a top surface and a bottom surface opposite the top surface; a plurality of electrical contacts disposed in at least two parallel lines at least in part within the insulative housing; and a shield. Each electrical contact may include a first contact portion extending above the top surface of the insulative housing. The shield may include a body disposed at least in part within the insulative housing between two adjacent parallel lines of the at least two parallel lines; and a plurality of first shield contacts connected to the body. The plurality of first shield contacts may extend through the top surface of the insulative housing; and the plurality of first shield contacts may be configured such that when the top surface of the interposer is compressed against a substrate, shield contacts of the plurality of first shield contacts contact the body of the shield.

Optionally, each of the plurality of shield contacts comprises a beam comprising a first end coupled to and extending from the body and a second end coupled to the first end and bending away from the body.

Optionally, for each of the plurality of shield contacts, the first end of the beam is coplanar with the body of the shield and the second end of the beam has a distal contact end bent out of the plane of the body of the shield, where the distal contact end is configured to contact the body of the shield.

Optionally, for each of the plurality of shield contacts: the beam comprises an edge and a broadside, wider than the edge; and the shield contact is configured to contact the body of the shield via contact between the broadside of the distal contact end of the beam and the body of the shield.

Optionally, the shield comprises an edge adjacent the top surface of the insulative housing; and for each of the plurality of shield contacts: the beam comprises an edge and a broadside, wider than the edge; and the shield contact is configured to contact the body of the shield via contact between the broadside of the distal contact end of the beam and the edge of the shield body.

These techniques may be used alone or in any suitable combination. The foregoing summary is provided by way of illustration and is not intended to be limiting.

### BRIEF DESCRIPTION OF DRAWINGS

The accompanying drawings may not be intended to be drawn to scale. In the drawings, each identical or nearly identical component that is illustrated in various figures is represented by a like numeral. For purposes of clarity, not every component may be labeled in every drawing. In the drawings:

FIG. 1 is an exploded view of an illustrative electronic assembly including an interposer disposed between two components, in accordance with some embodiments;

FIG. 2A is a top perspective view of an illustrative interposer showing an array of electrical contacts and shield contacts in respective openings in a surface of the interposer;

FIG. 2B is a bottom perspective view of the illustrative interposer in FIG. 2A;

FIG. 2C is a side elevation view of the illustrative interposer of FIG. 2A, showing a plurality of electrical contacts and a plurality of shield contacts;

FIG. 3A is an enlarged view of a portion A of the illustrative interposer of FIG. 2A;

FIG. 3B is a perspective view of the housing of the interposer of FIG. 3A, sectioned along the line L-L of FIG. 3A;

FIG. 4 is a partially exploded view of the illustrative interposer of FIG. 2A, showing a plurality of integrated shields and electrical contacts inserted into the housing of the interposer;

FIG. 5A is a perspective view of a shield of the interposer of FIG. 4;

FIG. 5B is a perspective view of an alternative embodiment of a shield as may be used with an interposer having a lower stack height than the interposer of FIG. 2A;

FIG. 6 is a perspective view of the shield of FIG. 5A with a plurality of shield contacts stamped from a sheet of conductive metal, in state of manufacture in which the shield is attached to a carrier strip;

FIG. 7A is a perspective view of an electrical contact of the interposer of FIG. 2A;

FIG. 7B is a perspective view of an alternative embodiment of an electrical contact as may be used with an interposer having a lower stack height than the interposer of FIG. 2A;

FIG. 8A is a left, perspective view of an example of a shield usable with the interposer of FIG. 4 with the plurality of shield contacts in an uncompressed state, according to another embodiment;

FIG. 8B is an end view of the shield of FIG. 8A;

FIG. 8C is a left, perspective view of a shield of FIG. 8A with the plurality of shield contacts in a compressed state;

FIG. 8D is an end view of the shield of FIG. 8C;

FIG. 8E is an enlarged, left, top perspective view of a portion of the shield of FIG. 8C with the shield contact in the compressed state, showing a shunting area of a shield contact;

FIG. 8F is an enlarged, right, top perspective view of a portion of the shield of FIG. 8C with the shield contact in the compressed state, showing a shunting area of a shield contact;

FIG. 9 is a top plan view of the interposer of FIG. 2A;

FIG. 10A is a plot showing simulated near end crosstalk in an exemplary interposer with shields with non-shunted beams, at a victim contact with 17 active contacts surrounding the victim contact in a pattern in which every other contact is grounded; and

FIG. 10B is a plot showing simulated near end crosstalk in an exemplary interposer under the conditions of FIG. 10A, except that the shields have shunted beams.

### DETAILED DESCRIPTION

The inventors have recognized and appreciated techniques that enable simple and reliable manufacture of a small footprint interposer for operation with high-speed signals. The interposer may have shields that may be readily integrated into the interposer while occupying only a small area. Despite the compact structure of the shields, they may make reliable connections to ground to provide high shielding effectiveness. Techniques as described herein may enable construction of an interposer with closely spaced electrical contacts to carry high-speed signals with crosstalk between high-speed signals below acceptable levels.

An interposer may have a housing and a plurality of electrical contacts in respective openings in the housing. The interposer may have one or more shields, which each having a body in a vertical plane perpendicular to top and bottom surfaces of the interposer housing disposed between electrical contacts. The plurality of electrical contacts in the interposer may be arranged in a plurality of lines (e.g., rows or columns), and one or more shields may be disposed between two lines of electrical contacts that are adjacent opposing sides of the shield plate. The interposer housing may have one or more channels between the two lines of electrical contacts to receive the one or more shields. The electrical contacts may carry high-speed signals.

The shield may be formed by stamping a sheet of metal to provide a plate-shaped body. Further, each shield may include a plurality of shield contacts extending from edges of the body. These shield contacts may be fully or partially disposed in a same plane in which the shield plate is disposed. Such a shield may be thin, which minimizes the extra space required to place the shield between two lines of electrical contacts. Thus, the techniques as described herein do not require significant space for the shield, enabling a small footprint interposer. In some examples, the electrical contacts may be dual compression contacts and the shields may have contacts extending from two opposing edges of the shield body such that the footprint of the interposer may be the same at both a top and a bottom interface.

An interposer as described herein may have low cross talk, even at high frequencies, such as less than 6% far end crosstalk over a frequency range of 1 to 15 GHz, or, in some examples, higher frequency ranges. Further reductions in crosstalk may be achieved with certain shield designs. In some examples, the shield contacts may be configured to contact the shield body when compressed. Distal ends of the shield contacts, for example, may contact the shield body when compressed. Such contact may shunt the shield contacts, which has been found to further reduce crosstalk among signals passing through the interposer.

Moreover, a shield as described herein may facilitate signal paths through the interposer with an impedance that matches an impedance of signal traces within the substrates to which the interposer is mated. The impedance within the interposer, for example, may be matched to 50 Ohm single ended traces or 100 Ohm differential traces or 85 Ohm differential traces, in some examples.

Moreover, forming a shield with a body and contacts extending from one or more edges of the body may enable the interposer to be readily manufactured with a desired height. Such a capability may enable a system designer to design the PCBs or other substrates to which the interposer will mate and separately select the separation between those PCBs, as the interposer may be readily constructed to match the desired height without requiring changes to the footprint on the substrates for the interposer.

Techniques as described herein may also enable construction of an interposer with a versatile arrangement of contacts and shields to accommodate a wide range of applications. For example, shields may only be needed for electrical contacts carrying high-speed signals that are close to other electrical contacts also carrying high-speed signals. In contrast, shields may not be needed for electrical contacts carrying low-speed signals or power. In some examples, shields may be inserted into channels in an interposer housing. A housing may be made with channels between lines of openings that accommodate electrical contacts. Shields may be placed in these channels between some lines of electrical contacts and omitted between other lines of electrical contacts. In the example interposers described herein, the same shaped electrical contacts may also be used for low-speed signals and power connections.

Moreover, shields may be manufactured in lengths that match the lengths of the lines of contacts, or the shields may be of different lengths and one or more shields may be disposed between same two lines of electrical contacts where needed. The spacing of the plurality of shield contacts can match that of the plurality of electrical contacts of the interposer such that the plurality of shield contacts can be arranged to align with the plurality of electrical contacts of the interposer. For example, the plurality of electrical contacts and the plurality of shield contacts of an interposer, in combination, can be arranged in an array of columns and rows. Such a configuration may enable the interposer footprint on a PCB providing an interface for mating to the interposer to have ground pads for coupling to the shield contacts to be between pads that couple to electrical contacts adjacent two sides of the shield. Such a configuration may support high speed signals through the mating interface without unacceptable degradation of signal integrity.

Techniques as described herein may also enable simple manufacture of an interposer. Shields may be manufactured separately from other components of the interposer, and thus, do not require altering existing methods of manufacturing of electrical contacts. Each shield may also have shield contacts that do not connect to any of the electrical contacts of the interposer. The interposer may nonetheless generate an appropriate amount of contact force such that reliable and robust connections may be formed by a component pressed against a separable interface of the interposer. Electrical contacts may be dual compression contacts, such that the interposer may have two separable interfaces on opposing sides of an interposer housing. Accordingly, a shield may also have shield contacts on opposing edges of the shield body that form a portion of the two separable interfaces on opposing sides of the interposer housing. Each of these shield contacts may have a beam having a different structure and/or physical properties than the electrical contacts. For example, the beam of each shield contact may deflect at a different height than a beam of an electrical contact. The beam of each shield contact may have a different length and stiffness than that of a beam of an electrical contact, where the structure and physical properties of the shield contact can be configured to achieve, in combination with the plurality of electrical contacts, proper electrical contact with a mating component (e.g., a substrate, such as a PCB) having a flat surface. Nonetheless, as demonstrated herein, the shield contacts may be designed to provide a contact force, when the interposer is mated to a substrate, to sufficiently match that of the electrical contacts that both signal connections and ground connections are reliably made.

An interposer as described herein may be formed by inserting a plurality of electrical contacts into respective openings of a housing that are arranged in a plurality of parallel lines and by inserting one or more shields into one or more channels of the housing. The shields may be disposed between two lines of the openings for the electrical contacts. The channels may extend in a plane that is perpendicular to the top and bottom surfaces of the housing. The shield may be stamped from a sheet of metal such that a body of the shield and a plurality of shield contacts extending from opposing edges of the shield may be formed in the same stamping operation.

The channel may be completely open at a surface of the housing (e.g., the bottom). In such configuration, the shield can be slidably mounted into the channel through that surface of the housing towards an opposing surface (e.g., a top surface). The channel may be at least partially open at the opposing surface. For example, the channel may be partially closed at the top surface of the housing with a plurality of openings into the channel through the top surface of the housing. When the shield is inserted into the channel, the plurality of shield contacts may extend through the plurality of openings of the opposing surfaces of the housing.

A shield may have one or more retention features to retain the shield within the channel once inserted. In some examples, the retention features may engage with an interior wall of the channel and retain the shield in the corresponding channel after the shield is inserted therein. In some examples, the retention features may be or include one or more tabs cut from the shield body and bent to extend from a side of the body of the shield. In a non-limiting example, one or more tabs are made as part of a stamping during which the shield is formed from a sheet of metal. When the shield is inserted into the channel, the one or more tabs may spring outwards to engage a shelf or other engagement feature within the channel or may press against the interior wall of the channel such that the shield is retained in the channel.

During the same stamping operation, a carrier strip connecting to the shield may also be formed. The carrier strip may be disposed in a same plane in which the shield is disposed. The carrier strip can be used in the manufacture of the interposer. For example, the carrier strip can be held, such as by an assembly tool, to align a shield with a corresponding channel in the interposer. The carrier strip can be used to insert the shield into the corresponding channel. Once the shield is inserted into the corresponding channel, the carrier strip can be severed from the shield and removed.

In some examples, the shield may be stamped from a sheet of metal with a body and shield contacts. The shield contacts may be stamped as beams with a shape and length such that distal ends of the beams do not contact the body when compressed. In these examples, the beams may be in the same plane as the shield body, corresponding to a plane of a sheet of metal. In other examples, the beams may be shaped such that their distal tips contact the shield body when compressed. In these examples, a distal end of the beams forming the contacts may be bent out of the plane of the shield body, which may ensure reliable contact between the distal end of the shield contact and the shield body. In these other examples, when the distal ends of the beams are in contact with the shield body, shunting may further reduce crosstalk among signals passing through the interposer.

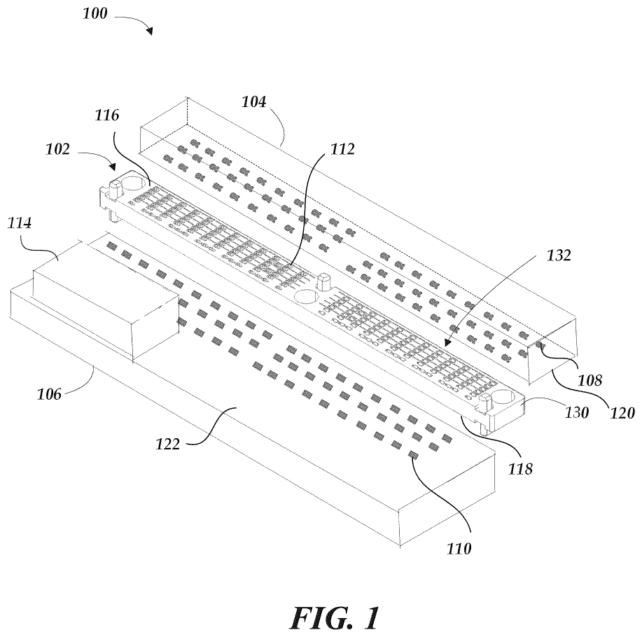

FIG. 1 is an exploded view of an illustrative electronic assembly including an interposer disposed between two components, which in this example are illustrated as two printed circuit boards. Here, electronic assembly 100 is shown with substrates 104 and 106, an interposer 102 between the substrates and semiconductor devices and other components attached to the substrates, of which component 114 is an example. Substrates 104 and 106 may be part of respective electronic components, implemented in this example as subassemblies including other electronic components. For example, substrate 106 may be a motherboard and substrate 104 may be a daughter card (e.g., a processor card).

In the example of FIG. 1, electronic assembly 100 is shown to have a mezzanine or stacking configuration, such that the electrical interface to interposer 102 on substrate 106 is in a plane parallel to the plane of the electrical interface to interposer 102 on substrate 104. In the example of FIG. 1, substate 104 includes pads 108 formed on the bottom surface 120 of substrate 104, and substrate 106 includes pads 110 formed on the top surface 122 of substrate 106. In this example, the bottom surface of substrate 104 is parallel to the top surface of substrate 106. The pads of each of the substrates 104, 106 may be connected via traces or other conducting structures within the substrates to semiconductor chips, such as electronic component 114, or other components mounted on the substrates.

In this example, the pads of the electrical interfaces on both substrate 104 and substrate 106 have a similar configuration, each with an array of pads. The pads within each array may be closely spaced, leading to miniaturization of electronic assembly 100. An interposer as described herein enables the pads to be closely spaced, center to center, at a distance in at least one dimension. The pads, for example, may be arranged in an array with multiple parallel lines of pads. In this example, the array of pads is a rectangular array.

During operation, pads 108 are in electrical contact with pads 110 via interposer 102. In this example, interposer 102 has dual compression electrical contacts 112, with contact portions of each electrical contact making contact with a pad 108 on the bottom surface 120 of substrate 104 and a pad 110 on the top surface 122 of substrate 106. Force to press the contact portions against the corresponding pads is generated by mechanical components of electronic system 100 (not shown in FIG. 1), pressing substrates 104 and 106 together, with interposer 102 between them.

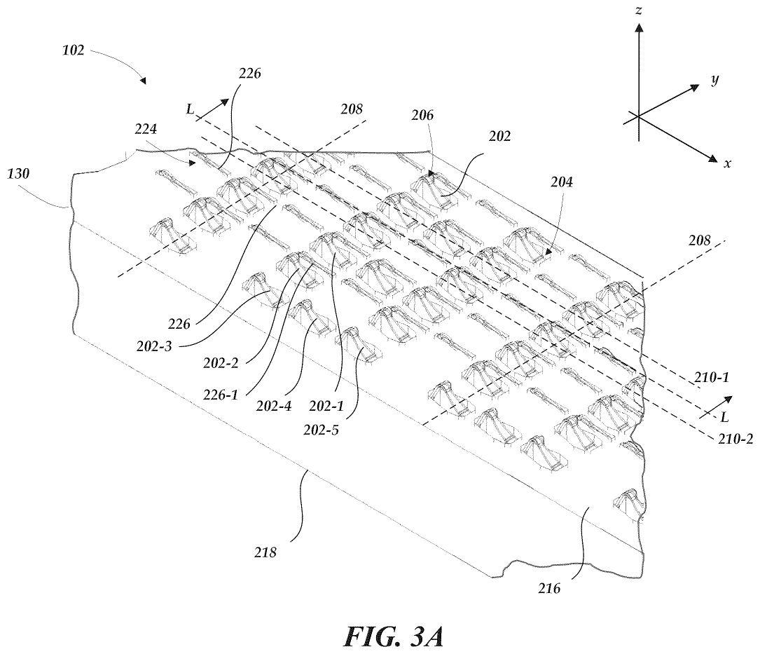

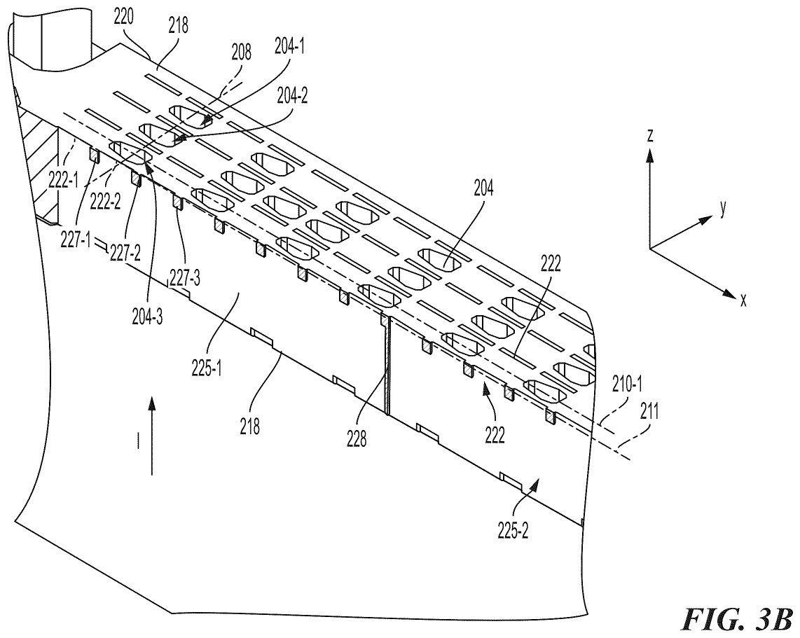

During operation, the signals carried by one or more of the electrical contacts adjacent the shield may be high-speed signals, depending on the mode of operation, which is controlled by components on the substrates (e.g., PCBs) and/or other electronic components (e.g., 114 in FIG. 1) of the electronic assembly 100. With a shield disposed between two electrical contacts, the crosstalk between the two electrical contacts caused by the high-speed signals carried by those two electrical contacts may be reduced. For example, in an exemplary operation, with reference to FIG. 3A, electrical contacts 202-1, 202-2 are adjacent opposing sides of shield 226-1. Thus, the crosstalk caused by high-speed signals in electrical contacts 202-1, 202-2 can be reduced by the shield 226 disposed between them.

In various modes of operation, the various electrical contacts may carry a high-speed signal or a low-speed signal, or a constant voltage (e.g., power signal). In some examples, two electrical contacts adjacent to each other and spaced at an adequate distance may be configured to carry a high-speed signal and a low-speed signal, respectively, without needing a shield between the electrical contacts. In an exemplary operation, electrical contacts 202-3 and 202-4 are adjacent to each other along an elongated axis (e.g., direction 210), and these electrical contacts may also be configured to respectively carry a high-speed signal and a low-speed signal or both may carry low-speed/power signals. In an exemplary operation, electrical contact 202-3 and electrical contact 202-2 are adjacent in a direction perpendicular to the elongated axis (e.g., 208), and these electrical contacts may be configured to respectively carry a high-speed signal and a low-speed signal or both may carry low-speed/power signals.

Interposer 102 may include an insulative housing 130, with a top surface 116, a bottom surface 118 parallel to the top surface, and a plurality of openings 132 through the housing 130. Interposer 102 may further include a plurality of electrical contacts 112. The plurality of openings may be arranged in an array and may extend between the top surface 116 and the bottom surface 118 of the housing 130. In some embodiments, the housing may be an insulative member, and the plurality of electrical contacts may be made of conductive metal, such as a copper alloy. Phosphor bronze, for example, may be used.

Interposer 102 may be mounted to a substrate, which may be substrate 106 in this example, via mechanical components (not shown). The mechanical components force contact portions of the electrical contacts against the pads 110 on substrate 106. The contact portions may be compliant, such as compliant beams at the bottom side 118 of interposer 102. When interposer 102 is pressed against substrate 106, those beams may be deflected, resulting in spring-loaded contacts. Latching structures (not shown in FIG. 1) may retain interposer 102 in place on substrate 106, generating the force that creates the spring-loaded contacts. Further, substrate 104 may be pressed into the top surface 116 of interposer 102. Interposer 102 or some other components of electronic assembly 100 may include latching structures (not shown in FIG. 1) designed to hold substrate 104 to the interposer and to press the substrate against the contact portions of the interposer contacts. These latching structures may be the same or different than the latching structures pressing interposer 102 and substrate 106 together. In some embodiments, the upper contact portions of the contacts of the interposer 102 may be compliant and may exert a force against pads 108 when substrate 104 is pressed against the interposer. Similarly, the lower contact portions of the contacts of the interposer 102 may be compliant and may exert a force against pads 110 when substrate 106 is pressed against the interposer.

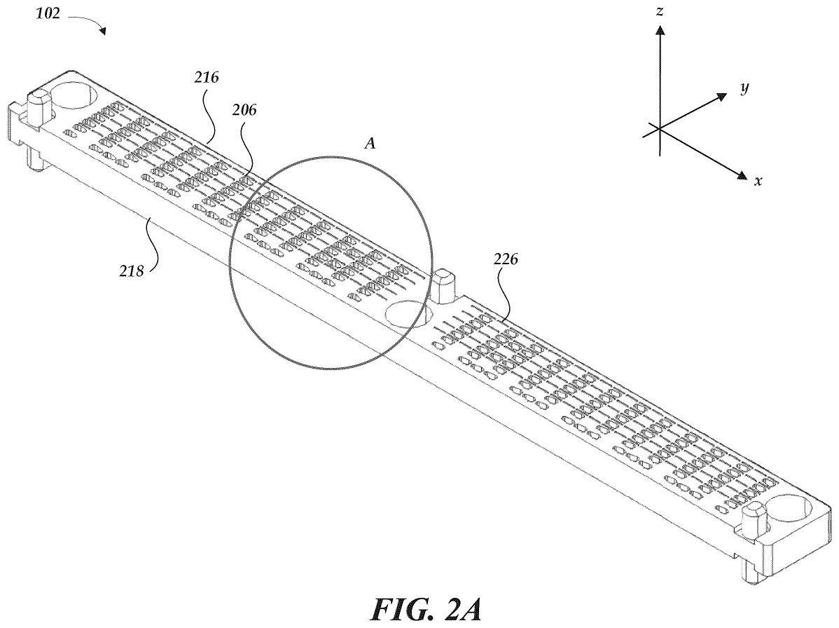

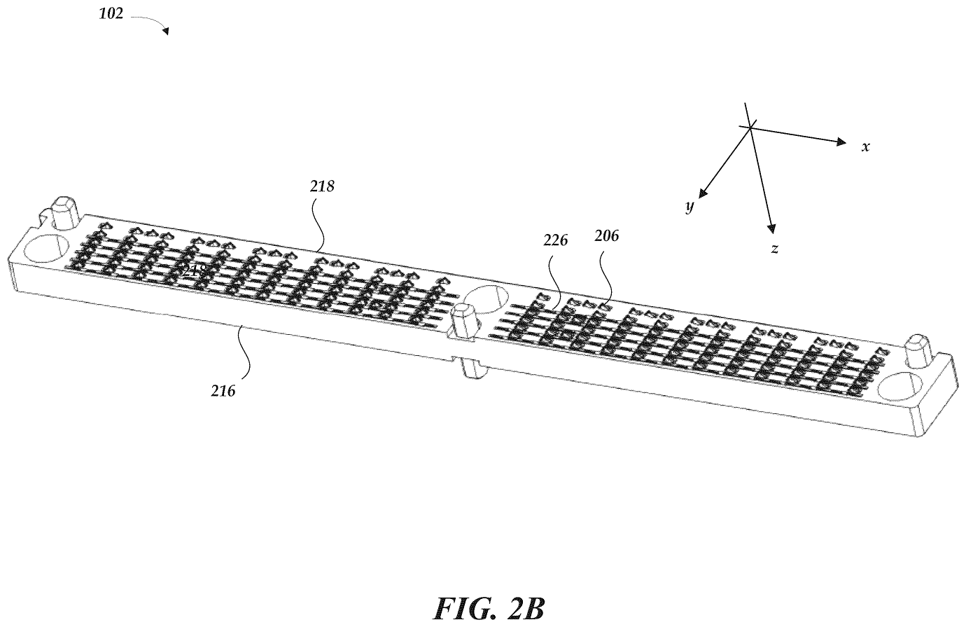

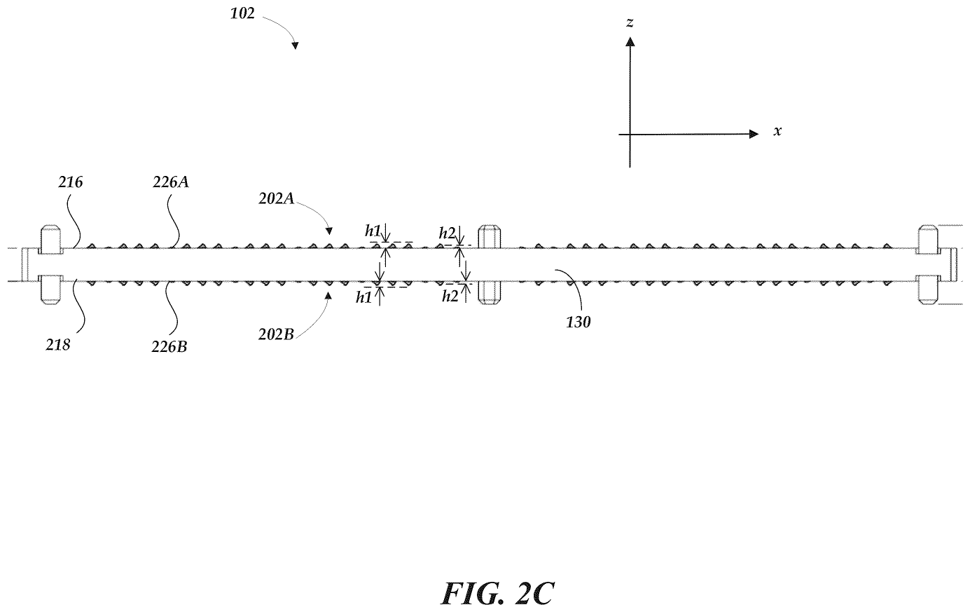

FIG. 2A is a top perspective view of an exemplary interposer 102 showing an array of electrical contacts and shield contacts in respective openings in a surface of the interposer. FIG. 2B is a bottom perspective view of the illustrative interposer in FIG. 2A. In this example, the mating interface at the bottom of the interposer, similar to the mating interface at the top surface, has multiple parallel lines of contacts extending through the bottom surface of the insulative housing. Contacts extending from shields are visible between the lines of electrical contacts, illustrating that shields may be positioned between adjacent lines of electrical contacts.

FIG. 2C is a side elevation view of the illustrative interposer 102 of FIG. 2A, showing a plurality of electrical contacts and a plurality of shield contacts extending through upper and lower surfaces of the insulative housing 130.

FIG. 3A is an enlarged view of a portion A of the illustrative interposer of FIG. 2A. FIG. 3B is a sectioned perspective view of the insulative housing 130 of the interposer of FIG. 3A taken through the line L-L of FIG. 3A. As shown in FIG. 3A, interposer 102 may have a plurality of electrical contacts 202 disposed within respective openings of the plurality of openings 204 of a housing 130 of interposer 102. In the illustration in FIG. 3A, each electrical contact includes a first contact portion 206 extending above the top surface 216 of the insulative housing 130. In this example, the contacts are dual compression contacts and, when compressed between two substrates, generate a contact force against both substrates. Accordingly, each of the contacts may similarly extend through bottom surface 218.

In the example in FIG. 3A, the electrical contacts are arranged in a rectangular array such that the lines of contacts are aligned to form a plurality of parallel columns extending in a column direction, here labeled direction y. Each of the electrical contacts has two beams (only top beams are visible in FIG. 3A), both of which are elongated along an elongated axis labeled x. The elongated axes x may be perpendicular to the column direction y. Thus, the electrical contacts along the elongated axes x may be in parallel lines 210-1, 210-2, etc.

As can be seen in FIGS. 2A and 2B, the plurality of openings 204 may extend between the top surface 216 and bottom surface 218 of the housing 130. Elongated axes of the plurality of openings 204 are aligned and arranged in a plurality of parallel lines in a first direction, such as the direction identified as x. In this example, the elongated beams of each of the electrical contacts 202 of interposer 102 are also aligned in direction x. The plurality of openings 204, or at least a subset thereof, may also be arranged in a plurality of lines, such as line 208, in a second direction, here labeled as the y direction. For example, the openings 204-1, 204-2, 204-3 are aligned in the y direction.

Interposer 102 may have one or more shields 224, each disposed between electrical contacts on opposing sides of the shield. Each shield may have a plurality of shield contacts extending through the top surface 216 and/or bottom surface 218 of the housing of the interposer. With further reference to FIG. 3B, housing 130 may additionally comprise a plurality of channels (e.g., 225-1, 225-2), each configured to receive a respective shield. As shown in FIG. 3B, the channels 225-1, 225-2 may each extend between the top surface 216 and the bottom surface 218 of the insulative housing 220. In this example, the channels extend in a vertical plane (e.g., a plane parallel to the plane labeled x-z), where the vertical plane is perpendicular to the top and bottom surfaces 216, 218 of the housing 220. In this example, each channel receives one shield. In this example, channels 225-1 and 225-2 are shown separated by a wall 228 between them, where wall 228 is an integral part of the housing 220 and may be formed, for example, as part of an operation in which the housing is molded.

In the illustrated configuration, a plurality of shields (e.g., 224) are disposed in a plurality of channels (e.g., 225-1, 225-2 in FIG. 3B). Each shield 224 includes a body and a plurality of shield contacts 226 extending from an edge of a body of the shield. A plurality of shield contacts 226 may extend through the top surface 216 of the insulative housing 130. In an interposer with a separable mating interface at the top and bottom, one or more of the shields 224 may also include shield contacts 226 extending from a second edge of the body of the shield and through the bottom surface 218 of the insulative housing 130.

Each channel (e.g., 225-1, 225-2) may be disposed between adjacent lines of openings of the plurality of openings 204. For example, the channel(s) 225-1 and/or 225-2 may be disposed between openings in lines 210-1 (see FIGS. 3A and 3B) and 210-2 (see FIG. 3A), where the openings along line 210-1 and openings along line 210-2 are respectively disposed on opposing sides of and adjacent the channel(s) 225-1, 225-2.

With further reference to FIG. 3B, the housing 220 may comprise additional channels disposed in additional vertical planes for receiving additional shields. Each such channel may be disposed between two adjacent electrical contacts (or group of electrical contacts). The adjacent electrical contacts (or group of electrical contacts) are disposed on opposing sides of the channel.

Channel 225-1 (and/or other channels, such as channel 225-2) of housing 220 may be partially closed at the top surface 216 of the housing such that a plurality of openings 222 (of which openings 222-1, 222-2 of channel 225-1 are numbered) are disposed at the top surface. Each of the opening may have an elongated direction aligned with the elongated direction of the channel (e.g., direction 211). Direction 211 may be parallel to the direction of the plurality of lines 210, in some examples. The plurality of openings (e.g., 222) of the channel are separated by respective portions of the housing (e.g., 226) at the top surface 216, where the plurality of openings 222 that extend from the channel are connected underneath the top surface via the channel. The plurality of openings 222 are configured to receive respective shield contacts of a shield to enable the shield contacts of the shield to extend above the top surface 216 of the housing 220.

The channel(s) 225 may be substantially or completely open at the bottom surface 218 of the interposer 102. This configuration enables a shield to be slidably mounted into a corresponding channel from the bottom surface of the housing towards the top surface of the housing. A shield may be inserted into a corresponding channel in the insulating housing 220, e.g., channel 225, from the bottom surface 218 of housing in a direction/that is perpendicular to the top and bottom surfaces of the housing. With reference to FIG. 3B, although the channel(s) are shown to be partially closed at the top surface of the interposer, the channel(s) 225 optionally may be completely open at the top surface.

The spacing between two electrical contacts may be small. Nonetheless, a shield may be disposed between two lines of electrical contacts. FIGS. 3A and 3B are enlarged views of portions of interposer 102. These figures show a shield 224 disposed in a channel 225 between two electrical contacts (e.g., 202-1, 202-2, or groups of electrical contacts) adjacent opposing sides of the shield, respectively. Thus, some of the pads 108 and/or 110 of the electrical assembly (see FIG. 1) may alternatively be in contact with corresponding shield contacts to connect to a shield.

The electrical contacts may be tightly spaced to enable a large number of connections to be made in a small area. In the illustrated example, the center-to-center spacing between adjacent electrical contacts in the same line may be 2 mm or less, such as between 1 mm and 1.8 mm or between 1.35 and 1.45 mm, in some examples. The center-to-center spacing between electrical contacts in adjacent lines may be 2.5 mm or less, such as between 1.0 and 2.5 mm or 2 mm, in some examples. Shields may fit between lines of electrical contacts with this spacing, such that the center-to-center spacing between electrical contacts and contacts of the shield may be 1.25 mm or less, such as between 0.5 and 1.25 mm or 1 mm, in some examples. Such a configuration may result in a rectangular array of electrical contact locations. An electrical contact may be provided at the intersection of each line and each column within the array. However, it is not a requirement that an electrical contact be positioned at each possible location in the array. If a lesser density of electrical contacts is adequate, the spacing may be non-uniform or electrical contacts may be arranged in an incomplete rectangular array, with electrical contacts at only a subset of the locations where lines and columns intersect.

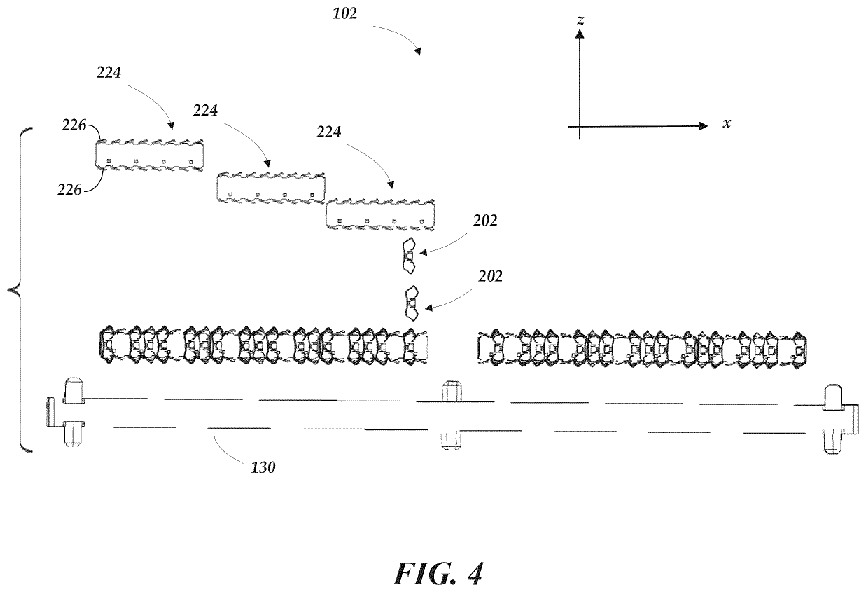

FIG. 4 is a partially exploded view of an illustrative interposer 102 showing a plurality of shields 224 and electrical contacts 202 as may be inserted into the housing 130 of the interposer 102. In this example, each of the plurality of shields 224 is of the same shape and aligned in the same direction. In this example, each of the shields 224 is elongated in a direction corresponding to the elongated dimension of interposer housing 130. Each of the shields is in a plane parallel to the plane labeled x-z. In this example, each of the plurality of electrical contacts 202 also has the same shape. The contacts 202 are aligned in parallel lines that parallel the shields. Each of the plurality of shields 224 may be inserted into a respective channel in the housing (e.g., channel 225-1 in FIG. 3B). As such, when the shield is inserted into a respective channel (e.g., channel 225-1 in FIG. 3B), the shield is disposed in a plane perpendicular to the top and bottom surface (e.g., 216, 218) of the insulative housing 220. As shown in FIG. 4, each of the plurality of shields 224 may include a plurality of shield contacts 226 extending from one edge or opposing edges of the shield.

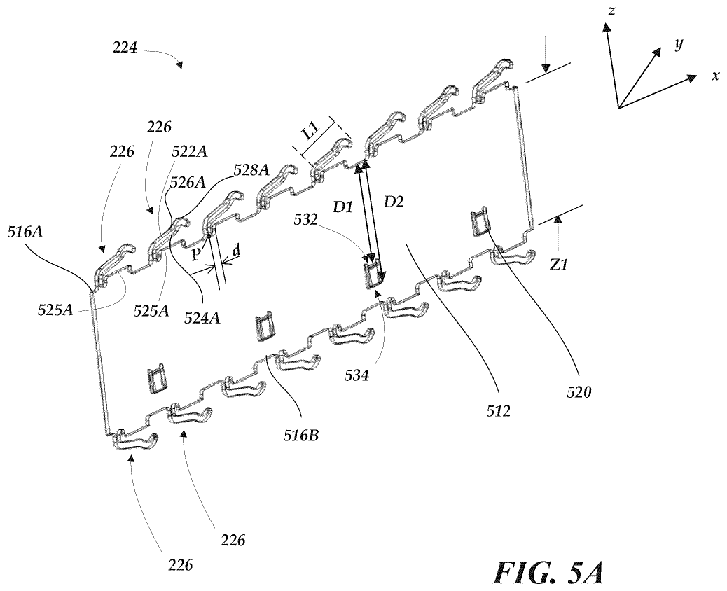

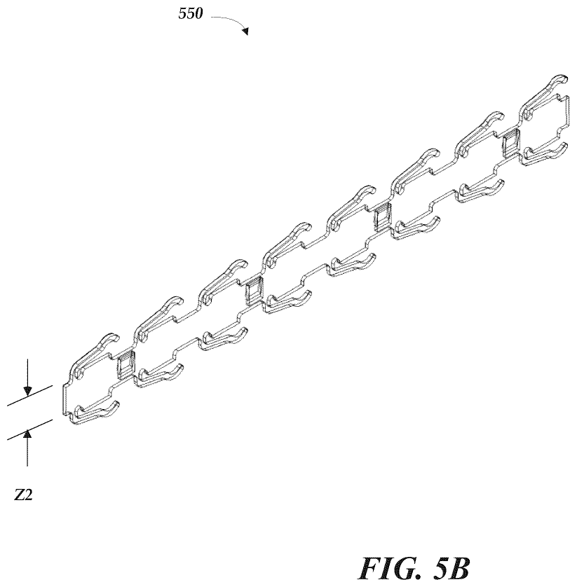

FIG. 5A is an enlarged view of a shield 224. Shield 224 may include a shield body 512. The shield body may be a plate. The shield may further include a plurality of shield contacts 226 extending from body 512 of the shield, such as at an edge of the shield 516A. In this example, each shield contact 226 includes a beam 522A which includes an inner edge 524A and outer edge 526A. For contacts extending from edge 516A, the inner edge of the shield contact faces the edge 516A of the shield. The outer edge of the shield contact includes a contact surface 528A.

Shield contacts 226 may be disposed in the same plane in which the shield is disposed, e.g., the x-z plane. The shield contacts 226 may be formed as part of the same stamping operation in which shield body 512 is stamped from a sheet of metal.

Shield 224 may additionally include an additional plurality of shield contacts 226 extending from body 512 of the shield at an opposite edge, e.g., 516B. In this example, the shield contacts extending from edge 516B are configured like the contacts extending from edge 516A. For contacts extending from edge 516B, for example, the inner edge of the shield contact faces the edge 516B of the shield, and the outer edge of the shield contact includes a contact surface.

In this example, shield body 512 has a height Z1 that is approximately the same as the height of the housing 130. When the shield is inserted into a corresponding channel in the housing (such as what is described in FIG. 3B), the plurality of shield contacts of the shield may extend above the top surface and/or below the bottom surface of the housing (see shield contacts 226A, 226B in FIG. 2C). Thus, shields 224 may provide dual compression contacts to engage with separable interfaces on top and bottom of the housing.

The beams of the shield (such as 522A) may deflect in the same plane in which the body of the shield is disposed. When the shield is inserted into a corresponding channel (e.g., 225 in FIG. 3B), the shield is disposed in a vertical plane, e.g., x-z plane. As such, the beam 522A deflects in the vertical plane in the z direction.

An edge of the shield body, such as edge 516A, may include a plurality of castellations 525A each facing the inner edge 524A of a respective shield contact 514A. As shown in FIG. 5A, each shield contact extends from the edge of the shield body (e.g., 516A) at a distance (e.g., distance d) from a respective castellation to which the shield contact faces. This gap d between the shield contact and a side of the corresponding castellation enables the shield contact to pivot about a point on the edge 516A from which the shield contact extends (e.g., point P). The castellation functions to limit the deflection of the corresponding shield contact, e.g., the movement in the negative z direction, and thus prevents overstressing of the beam of the shield contact.

In the illustrated embodiment in which shield contacts extending from edge 516B are configured the same as those extending from edge 516A, edge 516B may similarly have castellations that are positioned to function in the same way to prevent overstressing of contacts 226 extending from edge 516B.

With further reference to FIG. 5A, shield 224 may have one or more retention features, here illustrated as tabs 520. The retention features may be configured to enable the shield 224 to be slid into a corresponding channel and retained therein. For example, retention features may be provided by one or more tabs 520 protruding from the main surface of the shield body 512. When the shield is slid into a corresponding channel, the one or more tabs engage with the channel such that the shield is retained in the channel. The tabs may frictionally engage with the channel, such as by pressing against the interior wall of the channel. Alternatively or additionally, the tabs may engage with the channel by catching on a shelf or other feature within the channel. As yet another option, the tabs may engage with the channel by digging into the wall of the channel. Such a feature may operate asymmetrically, such that the shield may be inserted without tab engaging with the wall of the channel, but, if the shield is withdrawn, the tab may dig in.

As shown in FIG. 5A, the retention features may be formed directly from the shield body 512 by stamping the tab and pressing it in a direction perpendicular to the plane in which the shield body 512 is disposed. In this example, the tab is square, but the shape of retention feature can vary. For example, the tab may be a circle, a rectangle, a semi-circle or any other suitable shape. Regardless of shape, each tab may include a joint end which joins the tab and the shield body and a free end severed from the shield body.

For insertion of the shield with the first edge 516A of the shield inserted into a corresponding channel, the jointed end of the tab may be closer to the edge 516A than the free end. In a non-limiting example, tab 520 has an end 532 that joins the tab and the shield body, whereas all other sides of the tab are severed from the shield body. This end 532 is a joint end that is parallel to the edges 516A and/or 516B of the shield body. Joint end 532 is spaced from edge 516A by a shorter distance (D1) than free end 534, which is spaced by a distance (D2). This configuration enables the shield to be smoothly slidably mounted into the channel with the joint end 532 of the tab in first.

Channel 225 may be partially closed on the top surface of the housing such that the edge of the shield (e.g., 514A in FIG. 5A) may be pushed towards the top surface until it contacts one or more portions of the housing at the top surface (e.g., housing ribs 227-1, 227-2 . . . ) that separate the openings 222 (e.g., 222-1, 222-2). The partially closed channels may prevent the shield from coming out of the top surface of the housing. In some embodiments, housing ribs 227 (e.g., 227-1, 227-2, 227-3, . . . ) may be configured to control the insertion depth of the shield in the housing. The retention feature described herein in FIG. 5A may restrict the shield from being withdrawn through the lower surface of the housing. Even if the channel(s) (e.g., 225-1, 225-2 in FIG. 3B) are completely open at the top surface of the housing the retention features may provide sufficient engagement between the shields and the interposer housing that the shields do not easily fall out.

In some examples, a shield, while being retained in a corresponding channel, need not be rigidly locked in position in the vertical direction perpendicular to the top and bottom surfaces of the housing. The shield may be allowed to move in the vertical direction. Such a configuration may enable the shield to float within the channel to equalize force at the top and bottom mating interfaces.

FIG. 5B is a variation of a shield that may be used with an interposer of shorter stack height than interposer 102. As shown, shield 550 may be similar to shield 224 (FIG. 5A) except the height Z2 of the shield body is less than the height Z1 of shield body 512. Accordingly, shields 550 may similarly be inserted into channels of an insulative housing of an interposer shaped as described above for housing 130, except the upper and lower surfaces may be separated by a distance of Z2.

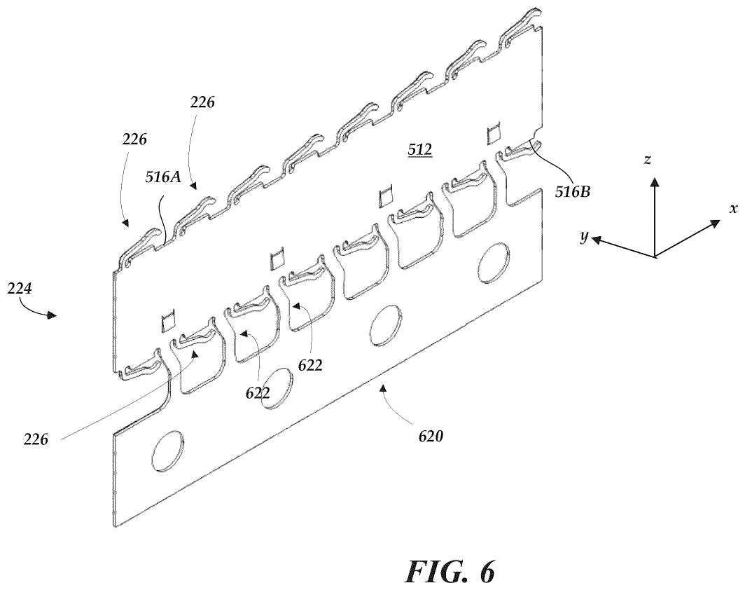

Regardless of the size of the shield, FIG. 6 illustrates a step in the manufacture that may facilitate insertion of the shield into a channel of an insulative housing of an interposer. Manufacture is illustrated with respect to a shield 224, but the same technique may be applied to a shield of different configurations, such as shield 550. FIG. 6 is a perspective view of a shield with a plurality of shield contacts 226 stamped from a sheet of conductive metal, in a state of manufacture in which the shield 224 is attached to a carrier strip 620. The carrier strip 620 can be used in the manufacture of the interposer. In some embodiments, a stamping operation on a continuous strip of metal may produce a series of blanks configured as shields 224 connected by a carrier strip 620. The carrier strip 620 connects to the edge 516B of the shield via one or more extensions 622. In this example, extensions 622 are bent such that the shield 224 and carrier strip 620 are in different, parallel planes.

The features of the shield as described herein may be simply formed in the same stamping operation. A plurality of shield contacts, for example, may be formed by stamping. As shown in FIG. 6, shield 224 may be stamped to include a shield body 512 and a plurality of shield contacts 226 extending from opposite edges 516A, 516B of the shield. Following the stamping operation, the shield body and the plurality of shield contacts may be disposed in a same plane, such as the x-z plane.

One or more retention features for the shields as described herein may also be formed as part of the stamping operation.

During manufacture of the interposer, the carrier strip can be held to align shield 224 with a corresponding channel in the interposer housing. The carrier strip 620 can be used to insert (e.g., push with force) shield 224 into the corresponding channel. Once shield 224 is inserted into the corresponding channel, the carrier strip can be severed from the shield and removed.

Severing the carrier strip 620 from the shield 602 may be performed using any suitable tool or by hand. For example, forces may be applied to the one or more extensions 622 in a lateral direction perpendicular to the plane in which the shield is disposed. This prevents the extensions 622 from staying in the same plane, resulting in severing the extensions 622 and the carrier strip from the shield.

Although embodiments are described with the example of a single shield and channel, it is appreciated that the manufacturing process may repeat for multiple shields and channels in a similar manner as described with reference to FIGS. 1-6.

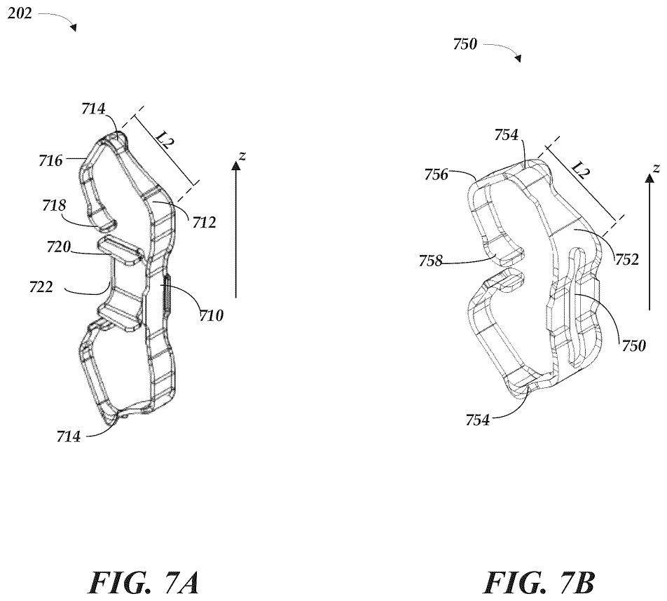

As described above, an interposer constructed by inserting contacts into openings and shields into channels of a housing may be made in different stack heights by using shields with bodies of different heights. The electrical contacts may also be of different height. FIG. 7A is an enlarged view of an electrical contact of the interposer 102. FIG. 7B is a variation of an electrical contact as may be used with an interposer of shorter stack height, such as might be implemented with shields 550 (FIG. 5B). As shown in FIGS. 7A and 7B, the electrical contact may be of a C-shape and may be self-shunting. Electrical contacts 202 and 750 each also have a shunting feature such that a first tip and a second tip of the C-shaped electrical contact are configured to be electrically connected to form a second conductive path between the first contact portion and the second contact portion of the electrical contact through the first and second tips of the electrical contact, when the electrical contact is compressed between a pair of substrates.

In the example illustrated, each of the electrical contacts 202 and 750 is symmetrical with a contact portion 714 or 754, respectively, at the top and the bottom of the contact. The contact portions are at the ends of beams 712 and 752, respectively, which are joined by backbones 710 and 750, respectively. The contact portions 714 and 754 press against conductive structures on the pair of substrates (such as pads on a surface of PCBs). Those conductive structures are connected through backbones 710 or 750.

Additionally, each of the electrical contacts 202 and 750 has a tip portion 716 and 756, respectively, extending beyond the contact portions 714 or 754, respectively. These tip portions may aid in retention of the electrical contact in an opening in the interposer housing. When electrical contacts 202 or 750 are compressed, the tip portions may contact other structures to create a second conducting path through the electrical contact. The top and bottom tip portions 716 or 756 are thus shorted, which can improve operation of the interposer particularly for high frequency signals.

In the case of electrical contact 750, the distal ends 758 of the top and bottom tip portions 756 come into contact with each other, directly shorting those tip portions 756 together. In the case of electrical contacts 202, a taller contact may be implemented by providing a longer backbone 710 and an intermediate portion 722 with upper and lower pads 720 bent from the intermediate portion 722. When electrical contact 202 is compressed, tip portions 718 contact pads 720, shorting the tip portions 718 through intermediate portion 722.

Further details of the C-shaped electrical contacts are described in U.S. Pat. No. 9,425,525, illustrating a contact such as contact 750 and U.S. Patent Application Publication No. 20230140379, filed Oct. 24, 2022, entitled “Tall Height Interposer.” illustrating a contact such as contact 202, both of which are incorporated by reference herein in their entireties. These prior publications describe, in addition to self-shunting, retention of dual compression contacts in an interposer housing.

Despite having different heights, electrical contacts 202 and 750 may be configured to have the similar mating characteristics. For example, beams 712 and 752 may have the same length L2 and/or other mechanical properties such that they provide the same contact force when compressed by the same amount. The contact force, for example, may be in the range of 5 to 60 N, when the beam is deflected between 0.05 mm and 0.2 mm as a result of compression of the interposer between a pair of substrates.

In some examples, the contact force of the electrical contacts may be balanced with the compression force provided by the shield contacts 226. The contact force, for example, may be within +/−10% or +/−20% for example. Because beams of contacts 202 or 750 have a different shape than the beams of shield contacts 226, the beam lengths may be different to provide a matched contact force. Alternatively or additionally, the beam of the shield contact may be designed to deflect less in the z direction than that of the beam of the electrical contact.

For example, with reference to FIG. 2C, for an electrical contact such as 202 or 750, when the electrical contact is in an uncompressed state, the first contact portion 714 or 754 of the electrical contact may extend a first distance h1 above the top surface 216 of the insulative housing. For a shield contact of a shield such as what is described in FIGS. 5A-5B, when the shield contact is in an uncompressed state, a contact portion of the shield contact may extend a second distance h2 above the top surface 216 of the insulative housing, wherein the second distance h2 is shorter than the first distance h1.

Such a configuration may accommodate for the stiffer beam in the shield contact, in comparison to beams 712 or 752, resulting from stamping the shield contacts from a sheet of metal. Despite the stiffer beam, when the interposer is mated to a pair of substrates, having h1 shorter than h2 results in less deflection of the shield contact beam in comparison to the deflection of beams 712 or 752. Alternatively or additionally, the stiffness of the beams of the shield contacts 226 may be reduced by making the beam length L1 (see FIG. 5A) longer than L2. Alternatively or additionally, other techniques may be used to match the contact force of the shield contacts and the electrical contacts. The shields, for example, may be made of a different metal than the electrical contacts and/or made with a different thickness.

In the illustrated embodiments, the electrical contacts 202 and/or 750 are symmetrical such that the beams at the upper interface may be the same as those at the lower interface. Similarly, the shields 224 and/or 550 have the same configuration at their upper and lower edges. Accordingly, features incorporated in the top interface, as described above, may be incorporated in the structures at the bottom interface. For example, an electrical contact may also extend the first distance h1 below the bottom surface 218 of the insulative housing when the electrical contact is in an uncompressed state, and a shield contact may extend the second distance h2 below the bottom surface of the insulative housing when the shield contact is in an uncompressed state.

Although electrical contacts and shield contacts are at different distances from the top/bottom surfaces of the housing when they are in an uncompressed state, they can accommodate a flat surface of a mating component (e.g., substrate 104, 106 in FIG. 1). For example, the mating components may be substrates 104, 106 (e.g., a PCB), each comprising a flat surface with a plurality of contact areas (e.g., pads) formed thereon. A contact portion (e.g., top portion) of an electrical contact and a contact portion of a shield contact may be in electrical contact with respective contact areas formed on the flat surface of the mating component on the top of the interposer. Similarly, a contact portion (e.g., bottom portion) of an electrical contact and a contact portion of a shield contact may be in electrical contact with respective contact areas formed on the flat surface of the mating component at the bottom of the interposer.

The inventors have recognized and appreciated that simply forming shields to fit compactly between lines of electrical contacts could result in shield contacts with physical properties sufficiently different than the properties of the electrical contacts to interfere with performance of the interposer under certain operating conditions. Design parameters as described herein may be selected to provide both shield contacts and electrical contacts that reliably mate with one or more substrates having flat surfaces.

The inventors have further recognized and appreciated designs for shield contacts that may further reduce crosstalk within an interposer. Such contacts may be configured to be self-shunting. Self-shunting shield contacts, for example, may be beams with distal ends that bend back towards the shield body such that, when the contact is compressed, the distal end contacts the shield body. In this compressed shape, the beam is coupled at both ends to the shield body with a contact point near a central portion of the beam. While not wishing to be bound by any particular theory of operation, it is theorized that shunting the distal end of the contact reduces radiation associated with currents in the contact. Such currents might be induced by one signal passing near the shield. The radiation induced by such currents might couple to contacts carrying other signals, causing crosstalk.

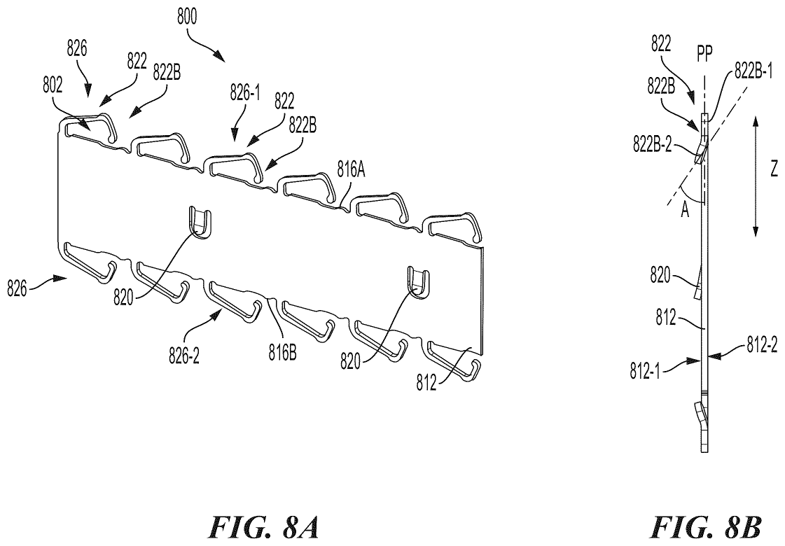

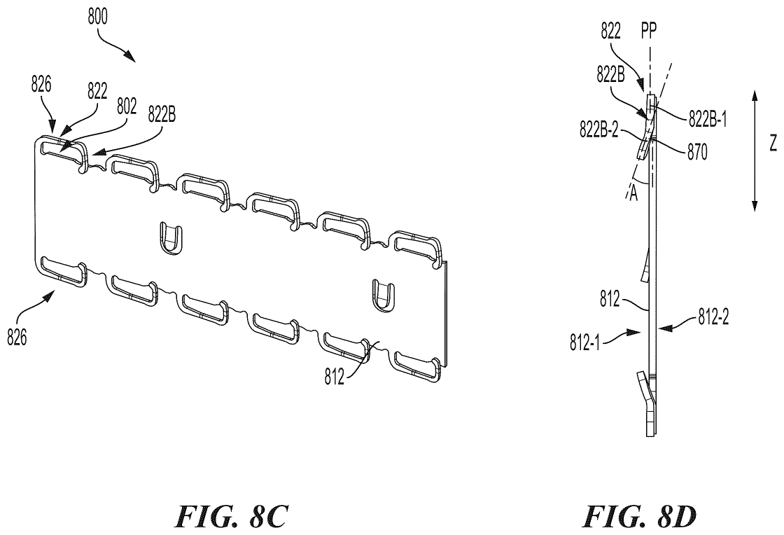

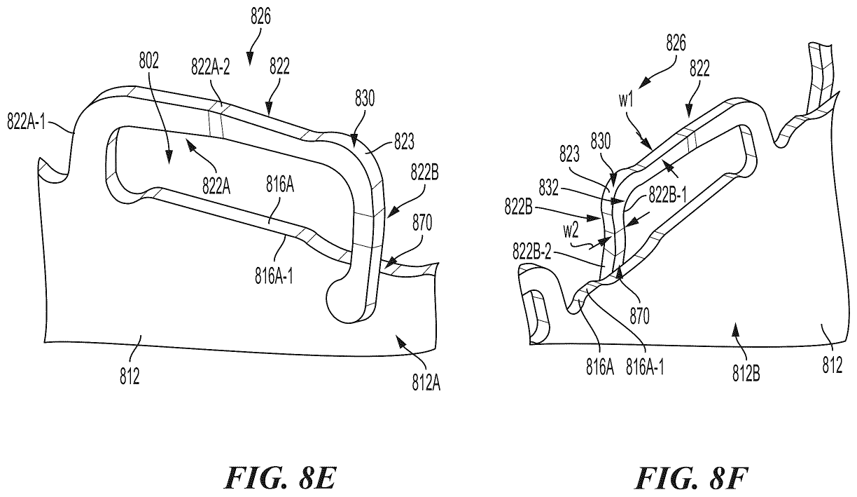

An example of such a shield contact design is shown in FIGS. 8A-8F, which show a shield 800 that may be used with interposer 102 (FIG. 1). FIG. 8A is a left, perspective view of an example of a shield 800 usable with the interposer of FIG. 4 with the plurality of shield contacts 826 in an uncompressed state. FIG. 8B is an end view of the shield of FIG. 8A. FIG. 8C is a left, perspective view of a shield 800 of FIG. 8A with the plurality of shield contacts 826 in a compressed state. FIG. 8D is an end view of the shield of FIG. 8C. FIG. 8E is an enlarged, left, top perspective view of a portion of the shield 800 of FIG. 8C with the shield contact 826 in the compressed state, showing a shunting area of a shield contact. FIG. 8F is an enlarged, right, top perspective view of a portion of the shield 800 of FIG. 8C with the shield contact 826 in the compressed state, showing a shunting area of a shield contact.

As shown in FIGS. 8A-8F, shield 800 may have a similar configuration as those of shields 224 (FIG. 5A) and/or 550 (FIG. 5B) with a difference being that the shield contacts 826 each include a beam (e.g., 822) that has a distal end (e.g., 822B) configured to contact the shield body 812 when the shield contacts 826 are in the compressed state (FIGS. 8E and 8F). This configuration enables the shield contacts to be shunted to ground when the shield contacts are compressed.

Similar to shields 224, 550, shield 800 may be inserted into channels of an insulative housing of an interposer shaped as described above for housing 130. The details of the configuration of shield 800 are further described with respect to FIGS. 8A-8F.

With further reference to FIGS. 8A-8F, beam 822 may include an arm portion (e.g., 822A in FIG. 8E) extending from the edge 816A of the shield body 812 and a distal end 822B extending from the arm portion 822A. When the beam 822 deflects, the arm portion 822A (FIG. 8E) moves up and down in the plane (e.g., PP in FIGS. 8B and 8D) in which the shield body 812 is disposed. In the example illustrated, arm portion 822A has two segments, one segment 822A-1 extending generally upwards from the edge of the shield body and a second segment 822A-2, extending generally parallel to the edge of the shield body.

The distal end portion 822B of the beam 822 may have at least a segment bent away from the plane PP (e.g., at an angle A) and configured to come into contact with the shield body 812 when the shield contact 826 is in the compressed state.

With reference to FIGS. 8B and 8D, the distal end 822B may include a first portion 822B-1 and second portion 822B-2 extending from the first portion 822B-1. The first portion 822B-1 may be disposed in the same plane in which the shield body 812 is disposed, e.g., plan PP. The second portion 822B-2 may be bent away from the plan PP, e.g., at a non-zero angle A. As such, when the shield contact 826 moves from the uncompressed state to the compressed state, beam 822 deflects in the Z direction (see FIG. 8B) at least partially in the plane PP. For example, portion 822B-1 may deflect in the plane PP. When the shield contact 826 is fully in the compressed state, portion 822B-2 of the shield contact 826 may be in contact with a corner 816A-1 of the edge (e.g., 816A in FIGS. 8E, 8F) of the shield such that the shield contact 826 is shunted to the shield body. As shown in FIGS. 8E and 8F, the shield contact 826 may be shunted to the shield body via a shunting area 870 (shown in FIG. 8F, as defined by an intersection between a broadside, e.g., 832 of the portion 822B-2 of the shield contact 826 and a corner 816A-1 of an edge (e.g., 816A) of the shield body 812).

With reference to FIGS. 8A and 8E, there may be clearance 802 between the beams 822 of shield contacts 826 and the edge 816A of the shield body 812. As a result, when the shield contacts 826 deflect to the compressed state, beam arms 822A of the beams 822 of the shield contacts 826 may not come into contact with the edge 816A (see FIG. 8E). The clearance 802 may be achieved by various configurations. For example, being different from shields 224, 550, the edge 816A of the shield 800 may have no castellations (see FIG. 8A).

In a similar configuration with respect to shields 224 (FIG. 5A), 550 (FIG. 5B), shield 800 may include two opposing edges, e.g., 816A, 816B, each edge having a plurality of shield contacts extending therefrom. For example, shield contacts 826 may extend from the first edge 816A or the second edge 816B and may have a similar structure as described above. In some embodiments, a first shield contact of the shield contacts 826, e.g., 826-1 and a second shield contact, e.g., 826-2 (see FIG. 8A) may extend respectively from the opposing edges (e.g., 816A, 816B) of the shield body. The shield contacts may be aligned at corresponding locations (e.g., top and bottom) on the opposing edges. In other variations, the locations of the first shield contact and the second shield contact may not be aligned.

As with shields 224 (FIG. 5A), 550 (FIG. 5B), shield 800 may include one or more retention features to hold the shield in the insulative housing. In this example, the retention features are tabs (e.g., 820 in FIG. 8A) configured to be pressed against the interior wall of the channel of the interposer to retain the shield in the channel. As shown in FIG. 8A, the one or more tabs 820 may protrude on a side (e.g., 812 in FIG. 8D) of the shield.

Although shield 800 is described in comparison to shields 224 (FIG. 5A), 550 (FIG. 5B), shield 800 may be configured to be usable with an interposer, such as interposer 102 (shown in FIGS. 1-4), independent of the configuration of shields 224 and 550. With references to FIGS. 1-4, in some embodiments, interposer 102 may include an insulative housing (e.g., 130 in FIG. 3A) including a top surface (e.g., 216) and a bottom surface (e.g., 218) opposite the top surface. Interposer 102 may include a plurality of electrical contacts (e.g., 202) disposed in at least two parallel lines (e.g., 210-1, 210-2) at least in part within the insulative housing 130. Each electrical contact (e.g., 202) may include a first contact portion (e.g., 206) extending above the top surface (e.g., 216) of the insulative housing.

With further reference to FIG. 3A and FIGS. 8A-8F, the interposer 102 may also include a shield, e.g., 800, which includes a body (e.g., 812 in FIG. 8A) disposed at least in part within the insulative housing between two adjacent parallel lines (e.g., 210-1, 210-2) of the at least two parallel lines. The shield 800 may include a plurality of first shield contacts (e.g., 826) connected to the body, where the plurality of first shield contacts 826 extend through the top surface 216 of the insulative housing 130 (FIG. 3A). These electrical contacts (e.g., 826) of the shield may be configured such that when the top surface 216 of the interposer 102 is compressed against a substrate, shield contacts 826 of the plurality of first shield contacts contact the body (e.g., 812) of the shield, and thus, are shunted.

In some embodiments, each of the plurality of shield contacts (e.g., 826) may be or include a beam 822 (FIGS. 8A, 8E). Beam 822 may include a first end (e.g., 822A) coupled to and extending from the body (812) and a second end (822B) coupled to the first end (822A) and bending toward the body 812. In this example, with reference to FIG. 8E, the first end 822A has a first segment 822A-1 extending from the edge of the body 812 and second segment 822A-2, extending from the first segment that bends to be generally parallel to the edge of the body 812. The second segment 822A-2 may include a contact location 830 designed to press against a ground pad or other conductive structure of the substrate to which the interposer is to be mated.

As shown in FIGS. 8B and 8D, the second end (822B) may be a distal end having a distal contact end (e.g., 822B-2) that is bent away from the body 812 at a non-zero angle A with respect to the plane of the body. As further shown in FIGS. 8B and 8D, for each of the plurality of shield contacts, e.g., 826, the first end of the beam (e.g., 822A in FIG. 8E) is coplanar with the body 812 of the shield 800, in the plane PP. The second end of the beam (e.g., 822B in FIG. 8F) may have a distal contact end (e.g., 822B-1) bent out of the plane of the body of the shield (PP), where the distal contact end may be configured to contact a corner 816A-1 of edge 816A of the shield when the shield contact 826 is in the compressed state.

With further reference to FIGS. 8E and 8F, in some embodiments, for each of the plurality of shield contacts, the beam (e.g., 822) may include an edge (e.g., 823) having a width (e.g., w1) and a broadside (e.g., 832) having a width (e.g., w2). The width of the broadside (w2) may be wider than the width of the edge of the beam (w1). In this configuration, the shield contact is configured to contact the body of the shield (812) via contact (area 870) between the broadside of the distal contact end of the beam (832) and the body of the shield (812). In some embodiments, shield 800 may have an edge (e.g., top edge 816A).

When shield 800 is installed in the interposer (e.g., 102 in FIGS. 1-4), the top edge 816A may be adjacent the top surface (e.g., 216) of the insulative housing (e.g., 130) of the interposer. In this configuration, the shield contact is configured to contact the body of the shield (812) via contact (e.g., at area 870) between the broadside of the distal contact end of the beam (832) and a corner of an edge (e.g., 816A) of the shield body 812. The opening of the channel may be sufficiently wide over some or all of its length to facilitate contact between the distal end of the shield contact and a portion of the shield.

The manufacture and installation process for the shields 224, 550 as described herein may also be used for manufacturing and installing shield 800 as shown in FIGS. 8A-8F. For example, the shield body 812 and shield contacts 826 may be stamped from the same sheet of metal in a similar manner as described with respect to shield 224, 550. In some embodiments, a portion of the shield contacts (e.g., the distal ends 822B) may be bent away from a plane of the shield before the shield is inserted into the channel of the housing. Additionally, and/or alternatively, the shield contacts 826 may have properties that provide reliable operation of the interposer.

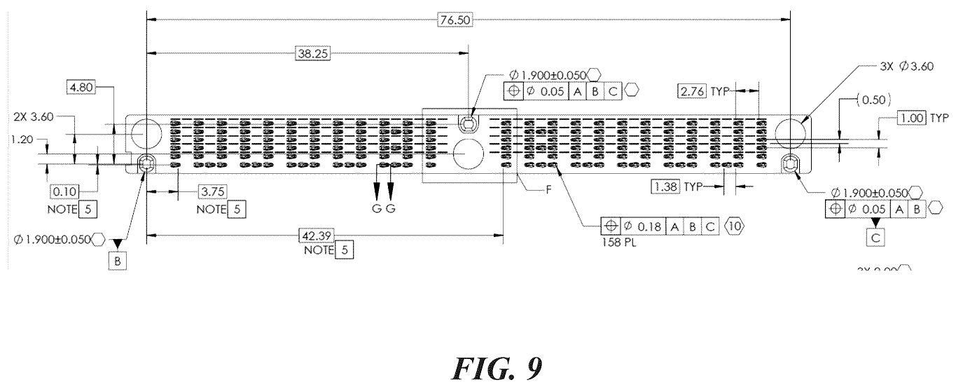

FIG. 9 is a plan view of an interposer made according to one or more of the techniques described herein, annotated with illustrative dimensions, in accordance with some embodiments. The interposer disclosed in various embodiments herein (e.g., in FIGS. 1-8F) allow tight spacing between groups of electrical contacts which may be used to carry high-speed signals, including single ended signals and/or differential signals. For example, two electrical contacts with a shield in between may be spaced at or about 1.0 mm, such as 0.8 mm. 0.9 mm, 1.0 mm, 1.1 mm, or 1.2 mm. Similarly, a plurality of shields may be disposed between plurality of lines of electrical contacts, where two shields with one or more electrical contacts disposed between them are disposed in parallel and may be spaced at or about 1.0 mm.

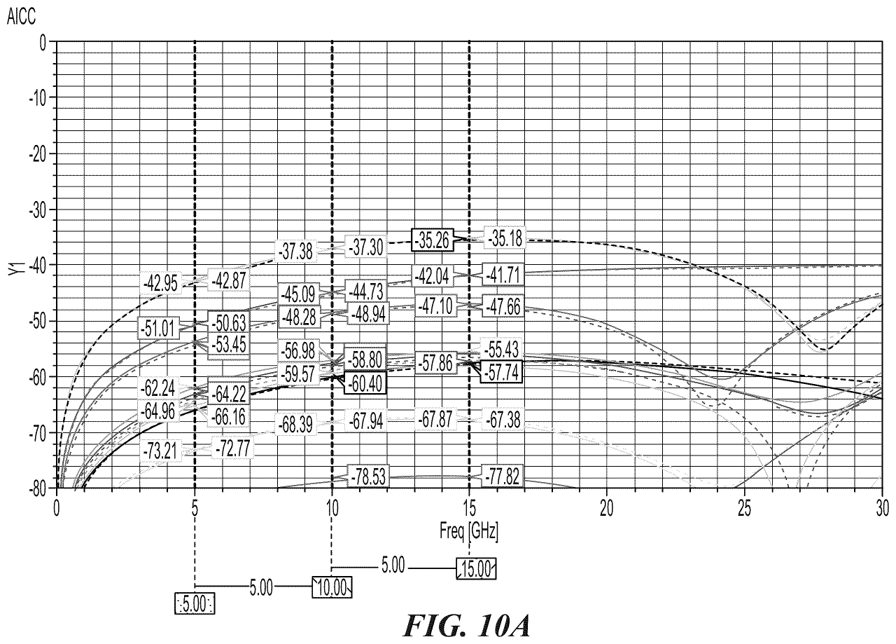

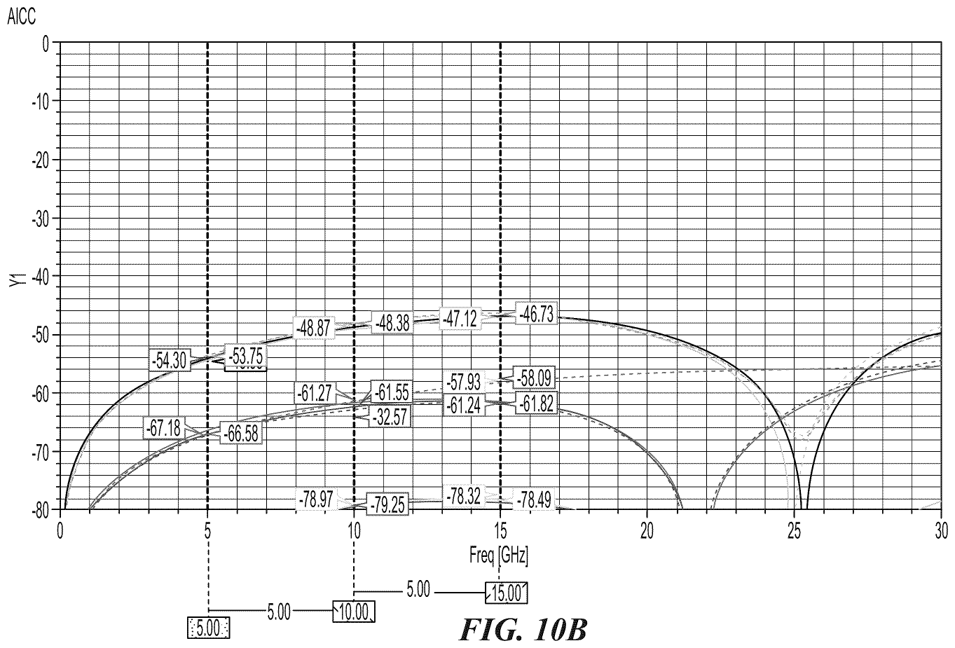

The various embodiments in FIGS. 1-9 may reduce crosstalk among electrical signals in the plurality of electrical contacts in an interposer. With the shunting features described in connection with FIGS. 8A-8F, crosstalk may be reduced further. For example, FIG. 10A is a plot showing simulated near end crosstalk in an exemplary interposer with shields with non-shunted beams, at a victim contact with 17 active contacts surrounding the victim contact in a pattern in which every other contact is grounded. FIG. 10B is a plot showing simulated reduced near end crosstalk in an exemplary interposer under the conditions of FIG. 10A, except that the shields have shunted beams. By comparing FIG. 10B to FIG. 10A at 10 GHz, peak crosstalk is shown to be reduced from −37.4 dB (FIG. 10A) to −48.3 dB (FIG. 10B), which results in an improvement about 11 dB. Shields with shunted beams, for example, result in multi-active crosstalk below −40 dB at frequencies up to and beyond 15 GHZ, and in this example up to and beyond 30 GHz, which expands the operating frequency range of the interposer.

Having thus described several embodiments, it is to be appreciated various alterations, modifications, and improvements may readily occur to those skilled in the art. Such alterations, modifications, and improvements are intended to be within the spirit and scope of the invention. Accordingly, the foregoing description and drawings are by way of example only. Various changes may be made to the illustrative structures shown and described herein.

For example, an interposer housing is pictured in which there are multiple channels, each sized to receive one shield. Optionally, a channel may be long enough to receive multiple shields.

As another example, an interposer configured for single ended signals is shown. In such a configuration, contacts for high-speed signals are disposed in lines with shields between the lines of high-speed signals, creating an alternating pattern of line of high-speed electrical contacts, shield, line of high-speed electrical contacts, shield, etc. Optionally, the interposer may be configured to pass high speed signals configured as differential signals. In this example, two adjacent contacts in the same line may be connected to carry one differential signal. In examples in which two electrical contacts in adjacent lines are connected to carry one differential signal, the lines of electrical contacts and shields may be arranged in a pattern comprising two lines of high-speed electrical contacts, shield, two lines of high-speed electrical contacts, shield, etc.

As yet another example, electrical contacts and shields are illustrated. In use, the shields may be connected to an AC ground, which may be earth ground or, depending on the system design, other low frequency reference, including a power source. The electrical contacts may be used for making other connections, such as for high-speed signals, low speed signals, power connections and/or AC grounds.

As yet another example, parallel lines of contacts are illustrated with the contacts in each line aligned in a direction perpendicular to the lines. Optionally, the contacts may be positioned in other arrangements. For example, the lines of contacts may be staggered in the line direction such that each line of contacts is offset from an adjacent line of contacts.

As yet another example, embodiments were illustrated in which shields were described as extending parallel with lines of electrical contacts. The lines extend in an elongated dimension of the interposer. Optionally, the shields may be positioned in channels that extend transversely to the elongated dimension of the interposer.

Further, embodiments were illustrated in which all of the shields in an interposer had the same size and were disposed in parallel. Optionally, shields of a mix of sizes may be included in an interposer and/or the shields of an interposer may have a mix of orientations. Some shields, for example, may be perpendicular to other shields.

Likewise, embodiments were illustrated in which all contacts within the interposer had the same shape and same orientation within the interposer housing. Optionally, contacts of different shapes may be included in an interposer. Contacts used for power connections, for example, may be wider than those used for high-speed signals.

As another example, shield retention was described based on engagement of retention features on a shield with an interposer housing. Optionally, retention features may alternatively or additionally be formed in the interposer housing. Heat staking, for example, may be used to form projections from the insulative housing that block the openings of the channels after the shields are inserted, capturing the shields within the channels.

As a further example, a dual compression interposer was used as an example of an interposer incorporating features as described herein. Alternatively, a single-sided interposer may be constructed using techniques as described herein. In such an interposer, the electrical contacts and shield contacts may have structures as described herein at a separable interface. At an opposing end, the electrical contacts and/or shields may be configured for attachment to a PCB. Rather than having compliant beams as described herein, the contacts and/or shields may have tails configured for attachment to a PCB at the opposing end. The tails, for example, may be configured for BGA attachment, gull wing soldering, pin in paste soldering, plated through hole soldering, or press-fit attachment to a PCB, for example.

As yet another example, a self-shunting shield contact was described to have a distal end that, when the contact is compressed, contacts the shield body. In other examples, the shield may have a projection from an edge aligned with the distal end such that the distal end contacts the projection from the body rather than the body directly.

Further, a self-shunting shield contact was described as contacting a corner of an edge of the shield body. Such a configuration is theorized to provide reliable and repeatable contact. The distal end may make contact in other ways, such as by pressing against the edge or by pressing against a broadside of the shield body.

As yet another example of a variation, a shield contact was pictured in which a distal end included two portions, one in plane and one bent out of the plane of the shield body. In other examples, only one such portion may be included.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

Use of ordinal terms such as “first.” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Terms signifying direction, such as “top,” “bottom,” “up,” “down,” “upwards” and “downwards,” were used in connection with some embodiments. These terms were used to signify direction based on the orientation of components illustrated or connection to another component, such as a surface of a printed circuit board to which a termination assembly is mounted. It should be understood that electronic components may be used in any suitable orientation. Accordingly, terms of direction should be understood to be relative, rather than fixed to a coordinate system perceived as unchanging, such as the earth's surface.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or.” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

What is claimed is:

1. An interposer, comprising:
an insulative housing comprising:
a top surface and a bottom surface opposite the top surface;
a plurality of first openings extending between the top surface and the bottom surface and arranged in a plurality of parallel lines; and
a channel extending between the top surface and the bottom surface and disposed between two lines of the first openings respectively adjacent opposing sides of the channel;
a plurality of electrical contacts each disposed within a respective opening of the plurality of first openings, wherein each electrical contact includes a first contact portion extending above the top surface of the insulative housing; and
a shield disposed in the channel, the shield comprising a plurality of first shield contacts extending from a first edge of the shield, wherein the plurality of first shield contacts extend through the top surface of the insulative housing.

2. The interposer of claim 1, wherein:
the channel is partially closed on the top surface of the insulative housing such that a plurality of second openings are disposed on the top surface along an elongated direction of the channel; and
shield contacts of the plurality of first shield contacts extend through respective openings of the plurality of second openings.

3. The interposer of claim 1, wherein the shield is disposed between and adjacent to a first group of electrical contacts of the plurality of electrical contacts in openings in a first line of the plurality of parallel lines and a second group of electrical contacts of the plurality of electrical contacts in openings in a second line of the plurality of parallel lines, whereby the shield reduces crosstalk between signals carried by the first group of electrical contacts and the second group of electrical contacts.

4. The interposer of claim 3, wherein:
for each electrical contact of the first and the second groups of electrical contacts, when the electrical contact is in an uncompressed state, the first contact portion of the electrical contact extends a first distance above the top surface of the insulative housing;
for each shield contact of the plurality of first shield contacts of the shield, when the shield contact is in an uncompressed state, a contact portion of the shield contact extends a second distance above the top surface of the insulative housing; and
the second distance is shorter than the first distance.

5. The interposer of claim 1, wherein:
each of the plurality of first shield contacts comprises a beam configured to deflect at least partially in a first plane perpendicular to the top and bottom surfaces of the insulative housing; and
when the shield contact of the plurality of first shield contacts is in a compressed state, a portion of the beam of the shield contact is in contact with a shield body of the shield.

6. The interposer of claim 5, wherein:
when the first shield contact is in the compressed state, the first shield contact is in contact with a corner of the first edge, whereby the first shield contact is shunted to the shield body.

7. The interposer of claim 5, wherein:
when the first shield contact is in the compressed state, the first shield contact is shunted to the shield body via a shunting area at a corner where a side of the body of the shield and the first edge intersect.

8. The interposer of claim 5, wherein:
for each of the plurality of first shield contacts, the beam comprises:
a first portion extending from the first edge of the shield and disposed in the first plane; and
a second portion extending from the first portion and having at least a portion bending away from the first plane.

9. The interposer of claim 8, wherein, for each of the plurality of first shield contacts, the second portion of the beam comprises:
a first portion extending from the first portion of the beam and is disposed in the first plane; and
an end portion extending from the first portion of the second portion of the beam at a non-zero angle with respect to the first plane and is configured to contact the first edge when the shield contact is in the compressed state.

10. The interposer of claim 9, wherein, for each of the plurality of first shield contacts:
the beam extends from the first edge of the shield at a distance to provide a clearance such that the beam does not come into contact with the first edge when the shield contact of the plurality of first shield contacts is in the compressed state.

11. The interposer of claim 1, wherein each electrical contact of the plurality of electrical contacts further includes a second contact portion extending below the bottom surface of the insulative housing.

12. The interposer of claim 1, wherein:
the channel comprises an interior wall, and
the shield comprises one or more tabs pressing against the interior wall of the channel such that the shield is retained in the channel.

13. A method for manufacturing an interposer comprising:
inserting a plurality of electrical contacts into respective first openings extending between a top surface and a bottom surface opposite the top surface of a housing, wherein the first openings are arranged in a plurality of lines;
stamping from a sheet of metal a shield including a plurality of shield contacts extending from a first edge of the shield; and
inserting the shield into a channel of the housing such that the plurality of shield contacts extend through the top surface, wherein the channel is disposed between two adjacent lines of the first openings.

14. The method of claim 13, wherein:
the channel of the housing is partially closed at the top surface of the housing such that a plurality of second openings are disposed on the top surface along an elongated direction of the channel; and
inserting the shield into the channel of the housing comprises inserting the shield into the channel such that the plurality of shield contacts of the shield extend through respective openings of the plurality of second openings above the top surface.

15. The method of claim 13, further comprising:
retaining the shield in the channel, wherein:
stamping the shield comprises stamping one or more tabs in the shield; and
retaining the shield in the channel comprises engaging the one or more tabs with a wall of the channel.

16. The method of claim 13, further comprising:
bending a portion of each of the plurality of shield contacts away from a plane of the shield before inserting the shield into the channel of the housing.

17. An interposer, comprising:
an insulative housing comprising:
a top surface and a bottom surface opposite the top surface;
a plurality of electrical contacts disposed in at least two parallel lines at least in part within the insulative housing, wherein each electrical contact includes a first contact portion extending above the top surface of the insulative housing; and
a shield comprising:
a body disposed at least in part within the insulative housing between two adjacent parallel lines of the at least two parallel lines; and
a plurality of first shield contacts connected to the body,
wherein:
the plurality of first shield contacts extend through the top surface of the insulative housing; and
the plurality of first shield contacts are configured such that when the top surface of the interposer is compressed against a substrate, shield contacts of the plurality of first shield contacts contact the body of the shield.

18. The interposer of claim 17, wherein:
each of the plurality of shield contacts comprises a beam comprising a first end coupled to and extending from the body and a second end coupled to the first end and bending away from the body; and
for each of the plurality of shield contacts, the first end of the beam is coplanar with the body of the shield and the second end of the beam has a distal contact end bent out of the plane of the body of the shield, where the distal contact end is configured to contact the body of the shield.

19. The interposer of claim 18, wherein:
for each of the plurality of shield contacts:
the beam comprises an edge and a broadside, wider than the edge; and
the shield contact is configured to contact the body of the shield via contact between the broadside of the distal contact end of the beam and the body of the shield.

20. The interposer of claim 19, wherein:
the shield comprises an edge adjacent the top surface of the insulative housing; and
for each of the plurality of shield contacts:
the beam comprises an edge and a broadside, wider than the edge; and
the shield contact is configured to contact the body of the shield via contact between the broadside of the distal contact end of the beam and the edge of the body of the shield.
